(19) United States
(12) Patent Application Publication
(10) Pub. No.: US 2020/0208746 A1
(43) Pub. Date: Jul. 2, 2020

(54) HYDRAULIC VALVE

(71) Applicant: Komatsu Ltd., Tokyo (JP)

(72) Inventors: Yuusuke Miyamoto, Tokyo (JP); Yuichi Hishinuma, Tokyo (JP); Shunsuke Tamura, Tokyo (JP)

(21) Appl. No.: 16/633,613

(22) PCT Filed: Jan. 24, 2019
(86) PCT No.: PCT/JP2019/002327

§ 371 Date: Jan. 24, 2020

(30) Foreign Application Priority Data
Mar. 26, 2018 (JP) 2018-058737

(51) Int. Cl. F16K 11/07; F15B 13/04

(52) U.S. Cl. CPC F16K 11/07; E02F 9/2267; F15B 13/0402

(57) ABSTRACT

A hydraulic valve includes: two spools arranged in a valve main body individually movable in an axial direction and in parallel with each other, end parts thereof being housed in a common pressure chamber, and having respective guide shaft parts on the end parts thereof; a return spring provided between each of the spools and the valve main body, so that a flow of oil is controlled by a movement of the two spools with respect to the valve main body against a spring force of each of the return springs in a case where a pilot pressure is supplied to the pressure chamber; and a coupling member that is arranged in bridged between the guide shaft parts of the two spools and that is pressed in a direction of becoming closer to the spools by the return springs.

### FIELD

The present invention relates to a hydraulic valve.

### BACKGROUND

For example, as a hydraulic valve that performs oil supply control with respect to a hydraulic cylinder, there is a hydraulic valve which includes two spools in a valve main body in order to increase a circulation amount of oil, for example. According to the hydraulic valve, since it is possible to supply oil through two ports, it becomes possible to increase an operating speed of the hydraulic cylinder (see, for example, Patent Literature 1).

### CITATION LIST

### Patent Literature

Patent Literature 1: Japanese Laid-open Utility Model Publication No. H07-022183

### SUMMARY

### Technical Problem

Incidentally, in Patent Literature 1, end parts of two spools are housed in a common pressure chamber, and the two spools are moved by supply of a pilot pressure to this pressure chamber. However, an external force such as a fluid force by a flow of oil, or a frictional force with respect to a valve main body is applied to each of the spools. The external force is not necessarily the same in the two spools, and there often is a difference between the two spools. A spool to which a large external force is applied is less likely to be moved compared to a spool to which a small external force is applied. Thus, as described above, when a pilot pressure is simply supplied to the common pressure chamber, the spool to which the small external force is applied moves before the spool to which the large external force is applied. Thus, a gap is kept generated in oil supply control by the two spools, and there is a possibility that activation of the hydraulic cylinder is influenced.

In view of the forgoing situation, the present invention is to provide a hydraulic valve that can accurately perform oil supply control even in a case where two spools are used.

### Solution to Problem

To attain the above object, a hydraulic valve according to the present invention includes:

two spools which are arranged in a valve main body in a state of being individually movable in an axial direction and being in parallel with each other, and individual end parts of which are housed in a common pressure chamber;

a return spring provided in such a manner as to be placed between each of the spools and the valve main body,

a flow of oil with respect to an oil path connected to the valve main body being controlled by movement of the two spools with respect to the valve main body against a spring force of each of the return springs in a case where a pilot pressure is supplied to the pressure chamber; and

a coupling member that is arranged in such a manner as to bridge the two spools and that is pressed in a direction of becoming closer to the spools by the return springs since being placed between each of the spools and the return springs.

### Advantageous Effects of Invention

According to the present invention, when a difference is generated between moving amounts of two spools due to a difference in an external force, a coupling member is inclined, and a return spring of a spool with a large moving amount is bent more than a return spring of a spool with a small moving amount. Thus, a moment is applied to the coupling member in a direction of recovering the inclination. As a result, the spool with a large moving amount is pushed back or the return spring of the spool with a small moving amount is bent by the coupling member, whereby the moving amounts of the two spools become identical to each other. Hereinafter, the above-described operation is repeatedly performed each time the moving amounts of the two spools become different from each other, and movement of the two spools is advanced without a large difference being generated therebetween. Accordingly, a situation in which a gap is generated in oil supply control by the two spools is prevented, and it becomes possible to accurately perform the oil supply control.

### BRIEF DESCRIPTION OF DRAWINGS

FIG. 1 is a view illustrating a hydraulic circuit to which a hydraulic valve according to an embodiment of the present invention is applied, and of a state in which each of two spools is arranged in a neutral position.

FIG. 2-1 is a view of a state in which the spools of the hydraulic valve move to a left side in the hydraulic circuit illustrated in FIG. 1.

FIG. 2-2 is a view of a state in which the spools of the hydraulic valve move to a right side in the hydraulic circuit illustrated in FIG. 1.

FIG. 3 is a main-part perspective view illustrating, in a broken manner, a part of end parts of the spools applied to the hydraulic valve illustrated in FIG. 1.

FIG. 4 is a main-part sectional view conceptually illustrating a relationship between forces applied to a coupling member in the hydraulic valve illustrated in FIG. 1.

FIG. 5 is a sectional view illustrating a hydraulic valve of according to a first modification example of the present invention, and of a state in which each of two spools is arranged in a neutral position.

FIG. 6 is a view illustrating a state in which the spools of the hydraulic valve illustrated in FIG. 5 operate, (a) being a main-part sectional view of a state in which the spools move to a left side, and (b) being a main-part sectional view of a state in which the spools move to a right side.

FIG. 7 is a sectional view of a hydraulic valve according to a second modification example of the present invention.

FIG. 8 is a sectional view of a hydraulic valve according to a third modification example of the present invention.

FIG. 9 is a view illustrating a hydraulic circuit to which a hydraulic valve according to a fourth modification example of the present invention is applied, and of a state in which each of two spools is arranged in a neutral position.

FIG. 10-1 is a view of a state in which the spools of the hydraulic valve move to a left side in the hydraulic circuit illustrated in FIG. 9.

FIG. 10-2 is a view of a state in which the spools of the hydraulic valve move to a right side in the hydraulic circuit illustrated in FIG. 9.

### DESCRIPTION OF EMBODIMENTS

In the following, a preferred embodiment of a hydraulic valve according to the present invention will be described in detail with reference to the accompanied drawings.

### EMBODIMENT

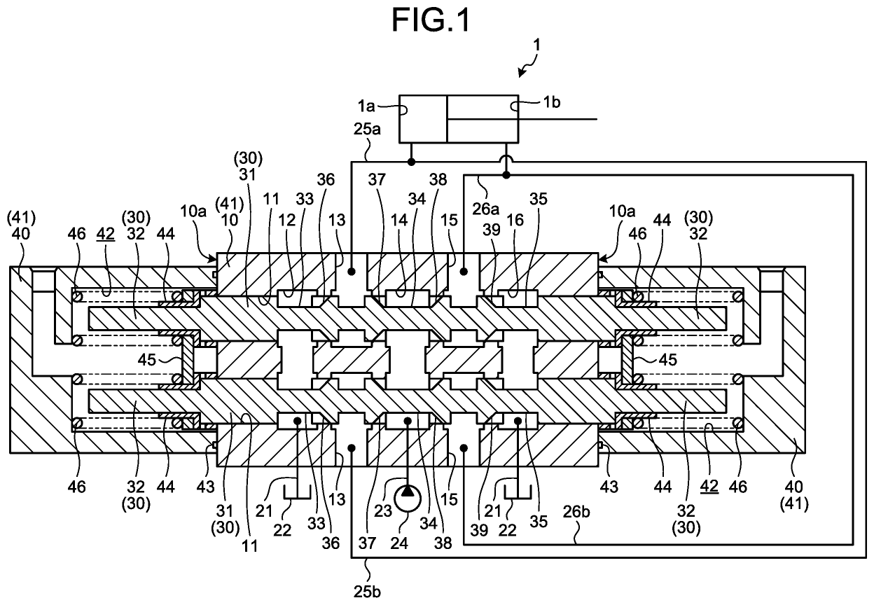

FIG. 1 is a view illustrating a hydraulic circuit to which a hydraulic valve according to an embodiment of the present invention is applied. The hydraulic valve exemplified here is to perform oil supply control with respect to a hydraulic cylinder 1 mounted in a working machine, and includes a valve base part 10.

The valve base part 10 is a block-shaped member having two reference end surfaces 10a in parallel with each other. In this valve base part 10, two spool holes 11 that are in parallel with each other are provided. The spool holes 11 are through holes both end parts of each of which are opened to the reference end surfaces 10a and which have round cross-sections, and are formed to have the same shape. In each of the spool holes 11, a first drain port 12, a first actuator port 13, a pump port 14, a second actuator port 15, and a second drain port 16 are provided in the order from a left side in the drawing. These ports 12, 13, 14, and 15.16 are formed in such a manner that positions in an axial direction thereof are identical to each other in the spool holes 11. Each of the first drain ports 12, the pump ports 14, and the second drain ports 16 communicate with each other in the two spool holes 11. Each of the first actuator ports 13 and the second actuator ports 15 is independent from each other in the spool holes 11.

A tank 22 is connected to each of the first drain ports 12, and the second drain ports 16 through a drain oil path 21, and a hydraulic pump 24 is connected to the pump ports 14 through a supply oil path 23. A bottom chamber 1a of the hydraulic cylinder 1 is connected to the two first actuator ports 13 through respective bottom oil paths 25a and 25b, and a rod chamber 1b of the hydraulic cylinder 1 is connected to the two second actuator ports 15 through respective rod oil paths 26a and 26b.

Spools 30 having the same shape are respectively arranged in the spool holes 11 in a state of being in parallel with each other. Each of the spools 30 is a columnar part in which a sliding base part 31 and two guide shaft parts 32 are formed integrally and which has a round cross-section shape, and can move in the axial direction individually. The sliding base part 31 has an outer diameter that can fit into the spool holes 11 in the valve base part 10. A length in the axial direction of the sliding base part 31 is configured to be longer than a distance between the reference end surfaces 10a. The guide shaft parts 32 are thin cylindrical parts provided on both end surfaces of the sliding base part 31 and are configured in such a manner that shaft centers thereof become identical to a shaft center of the sliding base part 31.

In each of the spools 30, a first annular groove 33, a second annular groove 34, and a third annular groove 35 are provided in an outer peripheral surface of the sliding base part 31. The first annular groove 33 is to switch the first actuator port 13 and the first drain port 12 between a communicating state and a blocked state. The second annular groove 34 is to switch the pump port 14 between a state of communicating with the first actuator port 13 and a state of communicating with the second actuator port 15. The third annular groove 35 is to switch the second actuator port 15 and the second drain port 16 between a communicating state and a blocked state.

Also, in each of the spools 30, a first communication groove 36 and a second communication groove 37 are provided in the sliding base part 31 between the first annular groove 33 and the second annular groove 34, and a third communication groove 38 and a fourth communication groove 39 are provided in the sliding base part 31 between the second annular groove 34 and the third annular groove 35. Although not clearly illustrated in the drawing, these communication groove 36, 37, 38, and 39 are formed in a plurality of positions at equal intervals along a peripheral surface of the sliding base part 31. The first communication groove 36 is provided in such a manner as to be opened from an outer peripheral surface of the sliding base part 31 to the first annular groove 33, and the second communication groove 37 and the third communication groove 38 are provided in such a manner as to be opened from the outer peripheral surface of the sliding base part 31 to the second annular groove 34. The fourth communication groove 39 is provided in such a manner as to be opened from the outer peripheral surface of the sliding base part 31 to the third annular groove 35.

More specifically, in a case where each of the spools 30 is arranged in a neutral position illustrated in FIG. 1, the first annular groove 33 is opened only to the first drain port 12, the second annular groove 34 is opened only to the pump port 14, and the third annular groove 35 is opened only to the second drain port 16. Here, a protrusion amount of the sliding base part 31 from the reference end surfaces 10a is configured to be the same at both ends of the valve base part 10.

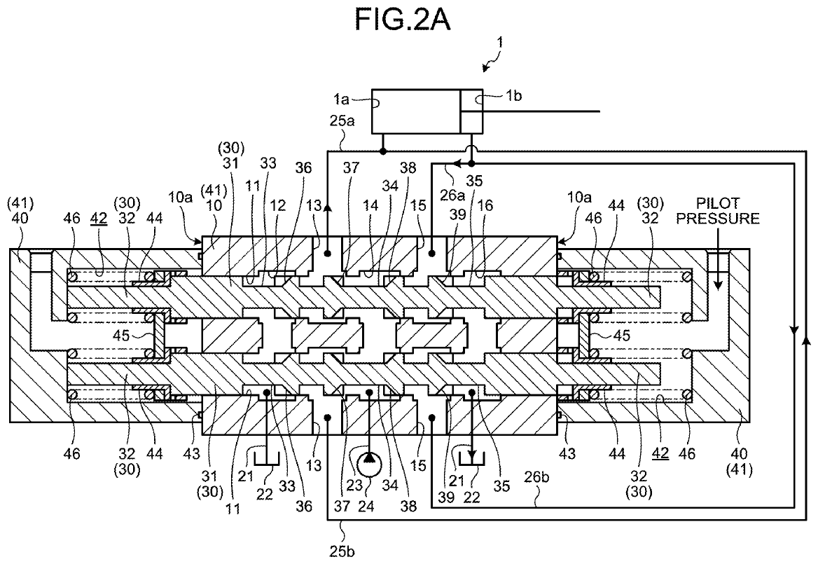

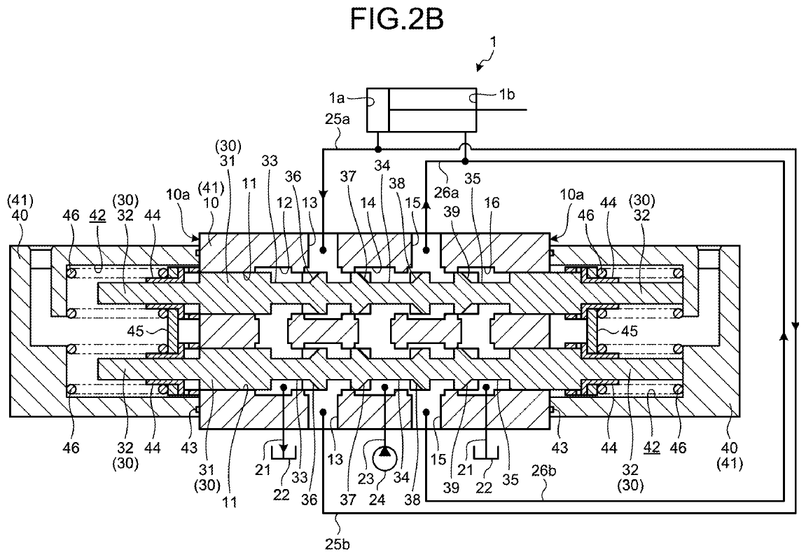

When each of the spools 30 moves to a left side from the neutral position illustrated in FIG. 1, as illustrated in FIG. 2-1, while a state in which the first annular groove 33 is opened only to the first drain port 12 is kept, switching to a state in which the second annular groove 34 makes the first actuator port 13 and the pump port 14 communicate with each other through the second communication groove 37 and the third annular groove 35 makes the second actuator port 15 and the second drain port 16 communicate with each other through the fourth communication groove 39 can be performed. On the one hand, when each of the spools 30 moves to a right side from the neutral position illustrated in FIG. 1, as illustrated in FIG. 2-2, while a state in which the third annular groove 35 is opened only to the second drain port 16 is kept, switching to a state in which the first annular groove 33 makes the first drain port 12 and the first actuator port 13 communicate with each other through the first communication groove 36 and the second annular groove 34 makes the pump port 14 and the second actuator port 15 communicate with each other through the third communication groove 38 can be performed.

As illustrated in FIG. 1, a housing box 40 is provided on each of the two reference end surfaces 10a of the valve base part 10. With the valve base part 10, the housing box 40 configures a valve main body 41 of the hydraulic valve. In the present embodiment, a housing box 40 that includes a pressure chamber 42 having one opened end is applied, and two spools 30 protruded to the outside from reference end surfaces 10a of a valve base part 10 are attached, in a state of being housed in a common pressure chamber 42, to the reference end surfaces 10a of the valve base part 10. Although not clearly illustrated in the drawing, attachment of the housing box 40 may be performed by screwing of a bolt into the valve base part 10 through a bolt insertion hole provided in the housing box 40, for example. An oil seal 43 is arranged between an end surface of the housing box 40 and a reference end surface 10a of the valve base part 10.

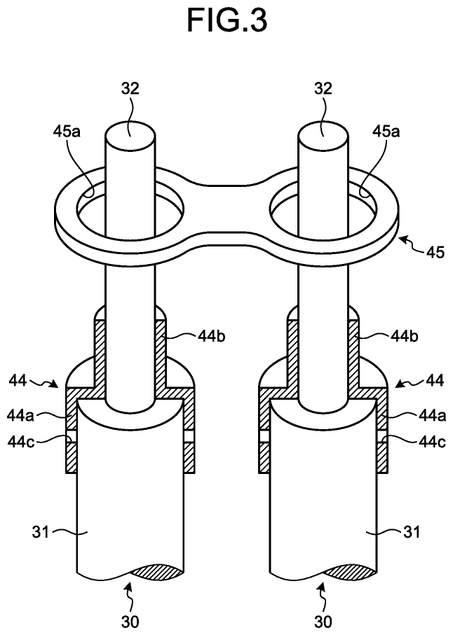

At an end part of each of the spools 30, a retainer 44 is arranged, and a coupling member 45 is arranged in such a manner as to bridge the two spools 30. As illustrated in FIG. 3, the retainer 44 includes a large-diameter part 44a into which the sliding base part 31 of the spool 30 is fitted and a small-diameter part 44b into which the guide shaft part 32 is fitted, these parts being formed integrally, and can relatively move in the axial direction with respect to the spool 30. As illustrated in FIG. 1, the large-diameter part 44a of the retainer 44 is configured in a dimension with which abutment on an end surface of the valve base part 10 and a reference end surface 10a of the valve base part 10 can be performed simultaneously in a case where the spool 30 is arranged in the neutral position. As illustrated in FIG. 3, oil holes 44c are provided in a plurality of positions in a circumferential direction in this large-diameter part 44a. The oil holes 44c are through holes formed in a radial direction of the large-diameter part 44a, and can apply a hydraulic pressure between the inside and the outside of the large-diameter part 44a. The small-diameter part 44b of the retainer 44 is configured to be shorter than the guide shaft parts 32 of the spool 30. The coupling member 45 is a flat member having two insertion holes 45a. Each of the insertion holes 45a is a round hole having an inner diameter larger than the small-diameter part 44b of the retainer 44 and smaller than the large-diameter part 44a of the retainer 44. A distance between central axes of the insertion holes 45a is set to be identical to a distance between central axes of the spools 30.

Moreover, as illustrated in FIG. 1, a return spring 46 is arranged at the end part of each of the spools 30. The return spring 46 is a coil spring having a central hole larger than the small-diameter part 44b of the retainer 44, and is housed in the pressure chamber 42 in a state of being compressed between an end surface of the housing box 40 and an end surface of the coupling member 45. That is, the coupling member 45 is placed between each of the spools 30 and the return springs 46 through the retainers 44, and the return springs 46 is provided in such a manner as to be placed between each of the spools 30 and the housing box 40 (valve main body 41).

In the hydraulic valve configured in the above-described manner, each of the spools 30 is kept in the neutral position illustrated in FIG. 1 by the return springs 46 at the both ends in a case where no pilot pressure is applied to any of the pressure chambers 42 at the both ends. That is, each of the spools 30 is pressed by the return springs 46 through the coupling members 45 and the retainers 44, and is kept in the neutral position in a state in which both of end surfaces of the large-diameter parts 44a provided at the both end parts abut on the reference end surfaces 10a of the valve base part 10. Thus, the first actuator port 13 and the second actuator port 15 are in a state of being blocked from any of the pump port 14 and two drain ports 12 and 16, and oil does not circulate to both of the bottom chamber 1a and the rod chamber 1b of the hydraulic cylinder 1 even in a case where the hydraulic pump 24 is driven. That is, the hydraulic cylinder 1 is kept in a stopped state.

From this state, for example, as illustrated in FIG. 2-1, when a pilot pressure is supplied to a pressure chamber 42 on the right side, each of the spools 30 moves to the left side against a pressing force of a return spring 46 arranged at an end part on the left side. As a result, oil discharged from the hydraulic pump 24 to the supply oil path 23 is supplied to the two first actuator ports 13 through the pump ports 14, the second annular grooves 34, and the second communication grooves 37, and is further supplied to the bottom chamber 1a of the hydraulic cylinder 1 through the bottom oil paths 25a and 25b. Simultaneously, oil stored in the rod chamber 1b of the hydraulic cylinder 1 is discharged to the second actuator ports 15 through the rod oil paths 26a and 26b, and is further discharged to the tanks 22 through the fourth communication grooves 39, the third annular grooves 35, the second drain ports 16, and the drain oil paths 21. Thus, the hydraulic cylinder 1 performs an extension operation.

On the one hand, as illustrated in FIG. 2-2, when a pilot pressure is supplied to a pressure chamber 42 on the left side from the neutral position illustrated in FIG. 1, each of the spools 30 moves to the right side against a pressing force of a return spring 46 arranged at an end part on the right side. As a result, oil discharged from the hydraulic pump 24 to the supply oil path 23 is supplied to the two second actuator ports 15 through the pump ports 14, the second annular grooves 34, and the third communication grooves 38, and is further supplied to the rod chamber 1b of the hydraulic cylinder 1 through the rod oil paths 26a and 26b. Simultaneously, the oil stored in the bottom chamber 1a of the hydraulic cylinder 1 is discharged to the first actuator ports 13 through the bottom oil paths 25a and 25b, and is discharged to the tanks 22 through the first communication grooves 36, the first annular grooves 33, the first drain ports 12, and the drain oil paths 21. Thus, the hydraulic cylinder 1 performs a contraction operation.

In such a manner, according to this hydraulic valve, oil circulates to the hydraulic cylinder 1 through the two first actuator ports 13 and the two second actuator ports 15 provided individually. Thus, it is possible to increase a circulation amount of the oil compared to a case where oil circulates through a single port. Thus, it becomes possible to increase an operation speed of the hydraulic cylinder 1, and there is an advantage of being able to make an operation more efficient.

In addition, according to this hydraulic valve, a large difference is not generated between moving amounts of the two spools 30 even in a case where there is a difference in an external force applied to the spools 30. Thus, when a difference is generated between the moving amounts of the two spools 30 due to a difference in the external force, a coupling member 45 is inclined and a return spring 46 of a spool 30 with a large moving amount is bent more than a return spring 46 of a spool 30 with a small moving amount. When bent amounts of the two return springs 46 are different, a moment is applied to the coupling member 45 in a direction of recovering the inclination. As a result, the spool 30 with a large moving amount is pushed back or the return spring 46 of the spool 30 with a small moving amount is bent by the coupling member 45, whereby the moving amounts of the two spools 30 become identical to each other.

Thus, according to the hydraulic valve in which the coupling member 45 is arranged in such a manner as to bridge the two spools 30 and the return spring 46 is applied to the spools 30 through the coupling member 45, the above-described operation is repeatedly performed each time a difference is generated between the moving amounts of the two spools 30, and movement thereof is advanced without a large difference being generated between the two spools 30. Accordingly, a situation in which a gap is generated in oil supply control by the two spools 30 is prevented, and it becomes possible to accurately perform the oil supply control with respect to the hydraulic cylinder 1.

In the hydraulic valve of the embodiment, as illustrated un FIG. 2-1, in a case where the spools 30 move to the left side, a coupling member 45 arranged on the left side of the spools 30 functions and the moving amounts of the two spools 30 become identical to each other. As illustrated un FIG. 2-2, in a case where the spools 30 move to the right side, a coupling member 45 arranged on the right side of the spools 30 functions and the moving amounts of the two spools 30 become identical to each other.

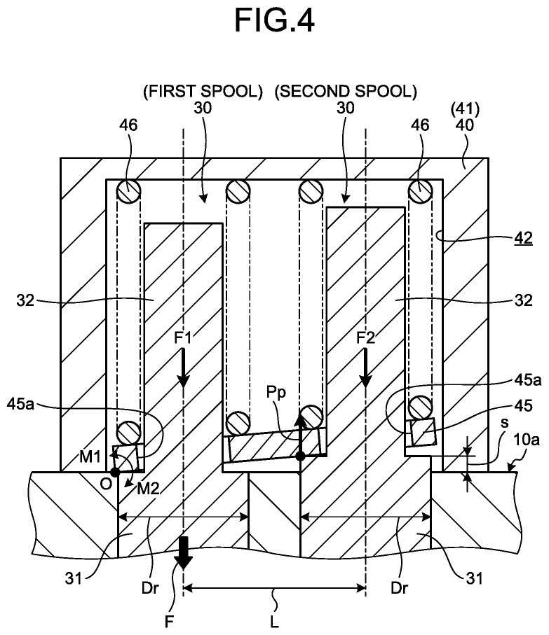

Here, an advantage of providing the retainers 44 at the end parts of the spools 30 and making the coupling members 45 abut on the spools 30 through the retainers 44 will be described with reference to FIG. 4.

Here, when an outer diameter of a sliding base part 31 in a spool 30: Dr, a pressure-receiving area of a spool 30: A, a distance between central axes of spools 30: L, a spring constant of a return spring 46: k, an attachment load of a return spring 46: f0, an allowance of an external force applied to two spools 30: F, and an allowable moving amount difference of two spools 30: s,

a force F1 to push back a first spool 30 with a large external force and a force F2 to push back a second spool 30 with a small external force are as follows.

F1=f0+F

F2=f0+k×s

From a balance of the forces, a pilot pressure Pp applied to a pressure chamber 42 is as follows.

Pp=(F1+F2)/2A

In consideration of a moment around a grounding point O between a sliding base part 31 and a coupling member 45 in the first spool 30, a counterclockwise moment M1 and a clockwise moment M2 are as follows.

M1=Pp×A×L=(F1+F2)×L/A

M2=(F1×Dr/2)+(F2×((Dr/2)+L))

In order to recover an inclined coupling member 45, the clockwise moment M2 needs to be larger than the counterclockwise moment M1. That is, it is necessary to satisfy the following expression.

M1−M2=((L−Dr)×F1/2)−((L+Dr)×F2/2)<0

Thus, in order to recover the inclined coupling member 45, it is only necessary to set an outer diameter Dr of the sliding base part 31 as large as possible. However, in a case where the outer diameter Dr of the sliding base part 31 is directly increased, it is also necessary to increase a distance L between central axes of the spools 30 due to a problem in strength of a valve main body 41, and the counterclockwise moment M1 is not reduced as intended.

In this respect, in a case where a retainer 44 is attached to an end part of a spool 30, a large-diameter part 44a of the retainer 44 abuts on a coupling member 45, and the counterclockwise moment M1 becomes similar to that of a case where an outer diameter Dr of a sliding base part 31 is increased. On the one hand, since the outer diameter Dr of the sliding base part 31 is not actually increased, it is not necessary to increase a distance L between central axes of the spools 30. As a result, it becomes possible to set the counterclockwise moment M1 small and the above-described effect becomes more outstanding when the retainer 44 is attached to the end part of the spool 30. Note that attachment of the retainer 44 to the end part of the spool 30 is not necessarily required in the present invention. A coupling member 45 may directly abut on a sliding base part 31 of a spool 30.

### First Modification Example

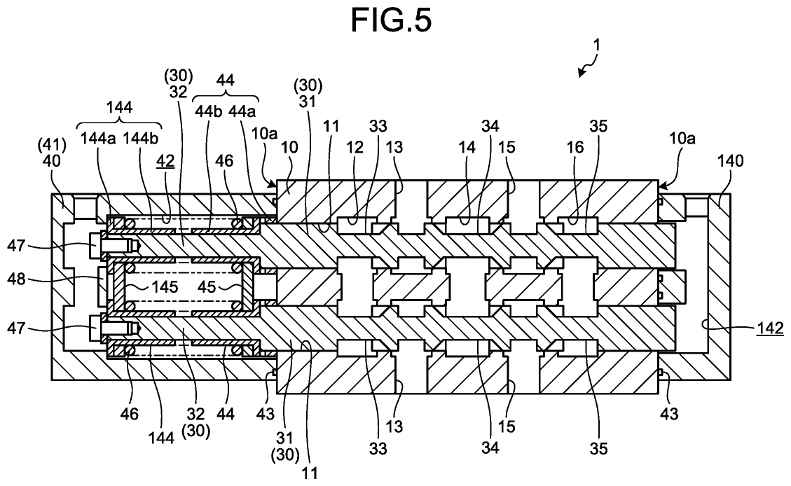

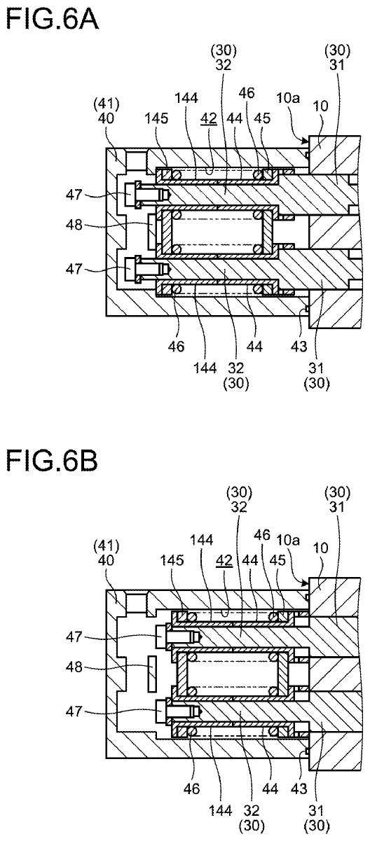

In the above-described embodiment, the hydraulic valve including the return spring 46 at each of both end parts of the spools 30 is exemplified. However, the present invention is not necessarily limited to this and may be also configured in a manner of the first modification example illustrated in FIG. 5 and FIG. 6.

That is, in a hydraulic valve of the first modification example, a spool 30 including a guide shaft part 32 only at one end part of a sliding base part 31 is applied. At the other end part of the spool 30, a retainer 44 and a coupling member 45 are provided between the sliding base part 31 and the guide shaft part 32 in a manner similar to that of the embodiment.

On the one hand, at an end part placed on a left side of the guide shaft part 32 in FIG. 5, a retainer 144 is arranged and a coupling member 145 is arranged in such a manner as to bridge two spools 30. The retainer 144 includes a small-diameter part 144b into which the guide shaft part 32 of the spool 30 is fitted and a large-diameter flange part 144a provided at an end part placed on a left side of the small-diameter part 144b, these being formed integrally, and can relatively move in an axial direction with respect to the spool 30. However, a movement of the retainer 144 is limited by a stopper bolt 47 screwed into an end part of the guide shaft part 32, and falling off from the guide shaft part 32 does not occur. The flange part 144a of the retainer 144 is configured in such a manner that an outer diameter thereof becomes the same as that of a large-diameter part 44a of the retainer 44 provided on a right side. The small-diameter part 144b of the retainer 144 has a dimension smaller than ½ of a length in an axial direction of the guide shaft part 32, and is configured to have substantially the same length as a small-diameter part 44b of the retainer 44 provided on the right side. The coupling member 145 has the same shape as what is provided on the right side of the spool 30. A return spring 46 is arranged in a compressed state between the two coupling members 45 and 145.

Also, in the hydraulic valve of the first modification example, an abutting wall part 48 is provided inside a housing box 40 that houses the guide shaft part 32 of the spool 30. The abutting wall part 48 can directly abut on the flange part 144a of the retainer 44 arranged on the left side, and the guide shaft part 32 and the stopper bolt 47 can be inserted into this. In this first modification example, each is configured in such a manner that an end surface of the flange part 144a abuts on both of the stopper bolt 47 and the abutting wall part 48 in a case where two spools 30 are arranged in a neutral position.

Note that configurations of a first drain port 12, a first actuator port 13, a pump port 14, a second actuator port 15, and a second drain port 16 provided in the valve base part 10 and configurations of a first annular groove 33, a second annular groove 34, and a third annular groove 35 provided in each of the spools 30 are similar to those of the embodiment. To a reference end surface 10a placed on the right side of the valve base part 10, a housing box 140 to cover two spool holes is attached.

In this hydraulic valve according to the first modification example, for example, when a pilot pressure is supplied to a pressure chamber 142 on the right side from a state of an arrangement in the neutral position illustrated in FIG. 5, each of the spools 30 moves to the left side against a pressing force of the return spring 46 as illustrated in (a) of FIG. 6. That is, in the state illustrated in (a) of FIG. 6, since the retainer 144 arranged on the left side is in a state of abutting on the abutting wall part 48 of the housing box 40, the return spring 46 is compressed by the coupling member 145 on the left side which member abuts on this retainer 144 and by the coupling member 45 on the right side which member moves to the right side along with movement of the spool 30. During this, when a difference is generated in moving amounts of the two spools 30, the coupling member 45 on the right side is inclined and a return spring 46 of a spool 30 with a large moving amount is bent greatly. Thus, similarly to the embodiment, the moving amounts of the two spools 30 become identical to each other by application, to the coupling member 45, of a moment in a direction of recovering the inclination.

On the one hand, when the pilot pressure is supplied to a pressure chamber 42 on the left side from the neutral position illustrated in FIG. 5, each of the spools 30 moves to the right side against a pressing force of the return spring 46, as illustrated in (b) of FIG. 6. That is, in the state illustrated in (b) of FIG. 6, since the retainer 44 arranged on the right side is in a state of abutting on the reference end surface 10a of the valve base part 10, the return spring 46 is compressed by the coupling member 45 on the right side which member abuts on this retainer 44 and by the coupling member 145 on the left side which member moves to the left side along with movement of the spool 30. During this, when a difference is generated in moving amounts of the two spools 30, the coupling member 145 on the left side is inclined and a return spring 46 of a spool 30 with a large moving amount is bent greatly. Thus, similarly to the embodiment, the moving amounts of the two spools 30 become identical to each other by application, to the coupling member 145, of a moment in a direction of recovering the inclination.

According to this hydraulic valve of the first modification example, since a configuration in which a return spring 46 is provided only at one end part of each spool 30 is included, it is possible not only to reduce the number of parts but also to reduce an inner volume of a housing box 40 provided on a right side of a valve base part 10 as much as possible and to reduce a space.

### Second Modification Example

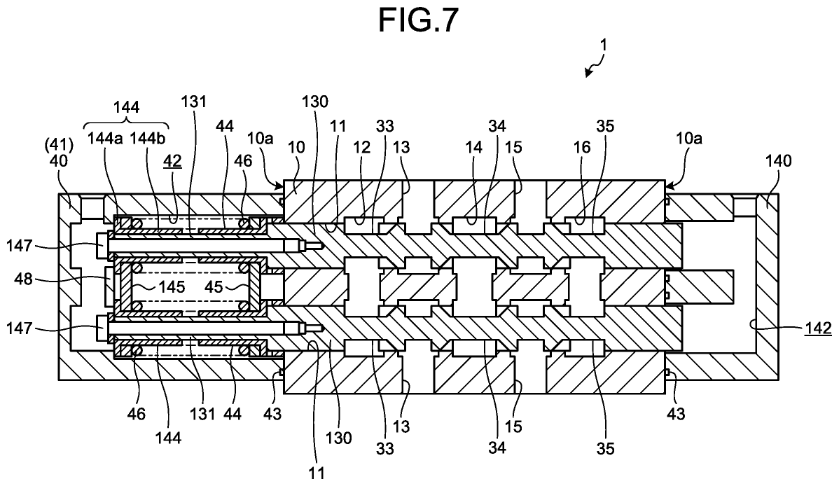

In each of the above-described embodiment and first modification example, a spool 30 in which a sliding base part 31 and a guide shaft part 32 are formed integrally is applied. However, the present invention is not necessarily limited to this. For example, a spool 130 including no guide shaft part 32 may be applied in a manner of the second modification example illustrated in FIG. 7.

That is, in the second modification example illustrated in FIG. 7, an end part of a cylindrical guide cylinder 131 is fitted into a hole provided in an end surface of a spool 130 and a stopper bolt 147 is screwed into the end surface of the spool 130 through a cylinder inner part of the guide cylinder 131, whereby the guide cylinder 131 is attached to the end part of the spool 130. This guide cylinder 131 is a configuration corresponding to the guide shaft part 32 of the first modification example. Retainers 44 and 144 and coupling members 45 and 145 are arranged respectively at an end part on a right side and an end part on a left side, and a return spring 46 is arranged in a compressed state between the coupling members 45 and 145. Note that the other configuration is similar to that of the first modification example, and the same sign is assigned thereto.

In this hydraulic valve according to the second modification example, an operation is performed similarly to the first modification example and moving amounts of two spools 130 become identical to each other by a moment to recover the inclined coupling members 45 and 145 in a case where a difference is generated between the moving amounts of the two spools 130.

### Third Modification Example

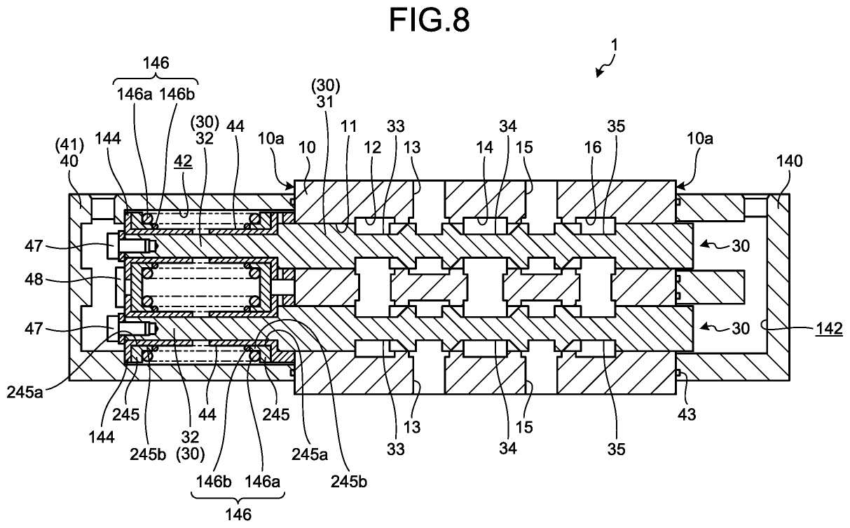

In any of the above-described embodiment, first modification example, and second modification example, a single coil spring is applied as a return spring 46. However, as described in the third modification example illustrated in FIG. 8, a return spring 146 may include two coil springs 146a and 146b having different outer diameters.

That is, in this third modification example, what includes a cylindrical spring seat 245b around an insertion hole 245a is applied as a coupling member 245, an internal coil spring 146b having a small diameter and a small wire diameter is arranged between facing parts in the spring seat 245b, and an external coil spring 146a having a large diameter and a large wire diameter is arranged between surfaces of a coupling member 45 placed around the spring seat 245b. Note that the other configuration is similar to that of the first modification example, and the same sign is assigned thereto.

In this hydraulic valve according to the third modification example, an operation is performed similarly to the first modification example and moving amounts of two spools 30 become identical to each other by a moment to recover the inclined coupling member 245 in a case where a difference is generated between the moving amounts of the two spools 30. In addition, since the return spring 146 includes the two coil springs 146a and 146b, it becomes possible to apply a pressing force identical to that of the first modification example to the spools 30 even when a spring length is short, and an effect of being able to reduce a space is also acquired.

### Fourth Modification Example

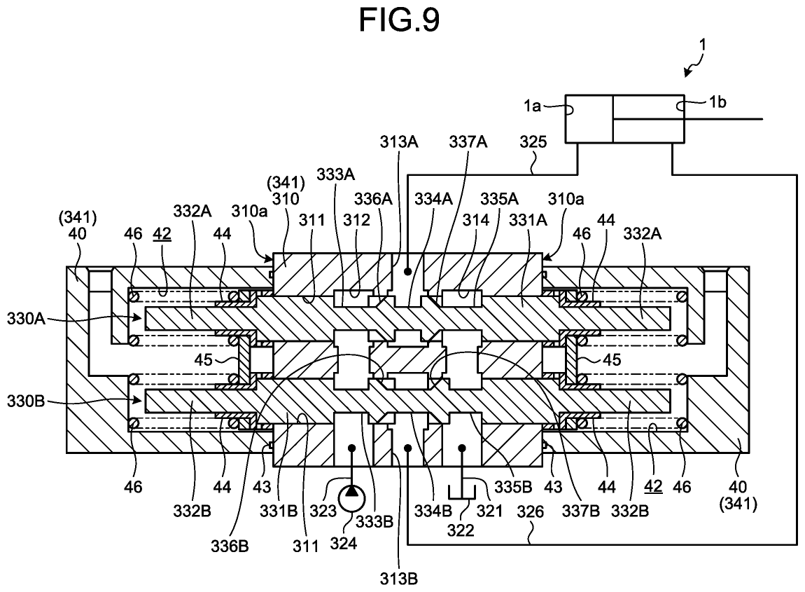

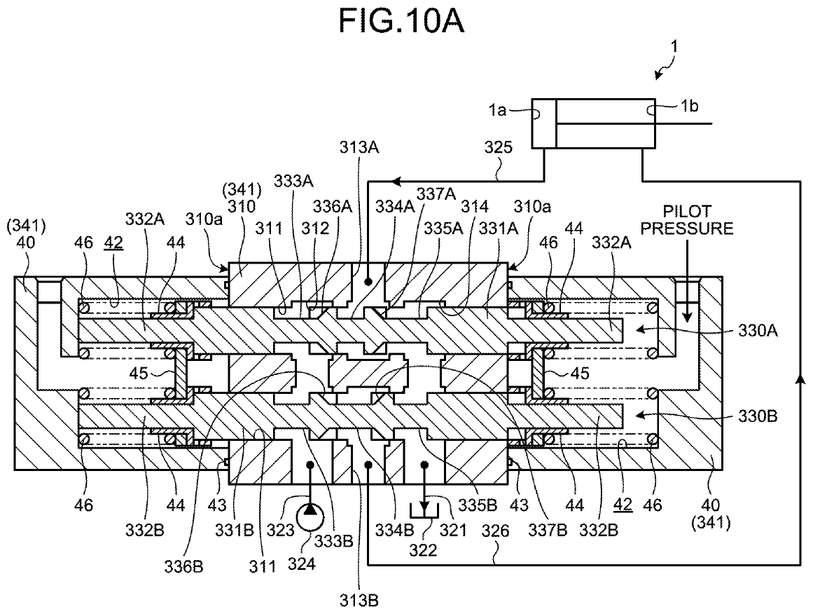

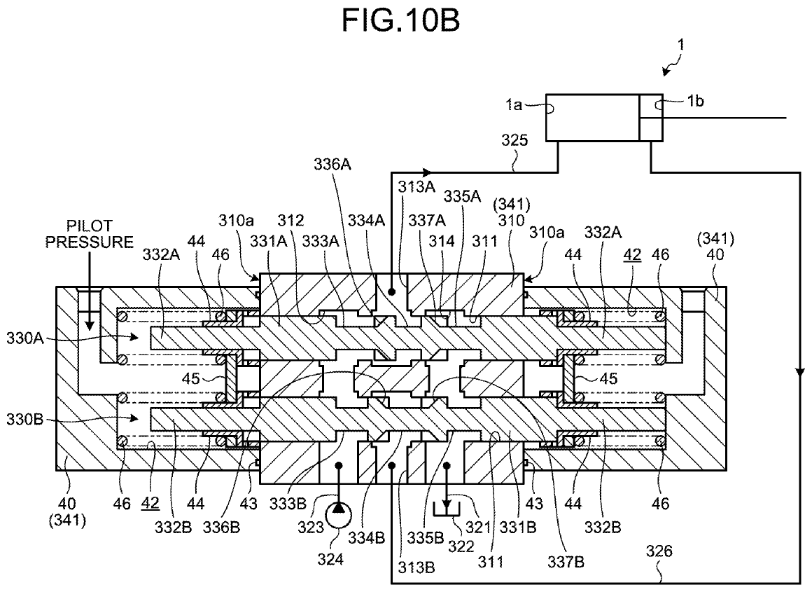

In any of the above-described embodiment, and first modification example to third modification example, two spools 30 in which annular grooves 33, 34, and 35 have the same configuration are applied. However, the present invention is not necessarily limited to this. For example, as illustrated in FIG. 9, FIG. 10-1, and FIG. 10-2, a hydraulic valve may include two spools 330A and 330B having different configurations of annular grooves.

That is, in a hydraulic valve according to the fourth modification example, a pump port 312, actuator ports 313A and 313B, and a drain port 314 are provided in this order from a left side in the drawing in each of two spool holes 311 that are provided in a valve base part 310 and that are in parallel with each other. These ports 312, 313A, 313B, and 314 are formed in such a manner that positions in an axial direction thereof are identical to each other in the spool holes 311. Although each of the pump ports 312 and the drain ports 314 communicate with each other in the two spool holes 311, the actuator ports 313A and 313B are independent from each other in the spool holes 311.

A hydraulic pump 324 is connected to the pump ports 312 through a supply oil path 323, and a tank 322 is connected to the drain ports 314 through a drain oil path 321. A bottom chamber 1a of a hydraulic cylinder 1 is connected to an actuator port provided on an upper side in the drawing (hereinafter, referred to as upper actuator port 313A in case of being distinguished) through a bottom oil path 325, and a rod chamber 1b of the hydraulic cylinder 1 is connected to the other actuator port (hereinafter, referred to as lower actuator port 313B in case of being distinguished) through a rod oil path 326.

Spools 330A and 330B are respectively arranged in the spool holes 311. The spools 330A and 330B are columnar parts in which sliding base parts 331A and 331B and two guide shaft parts 332A and 332B are formed integrally and which have a round cross-section shape, and can move in the axial direction individually. The sliding base parts 331A and 331B have an outer diameter that can fit into the spool holes 311 of the valve base part 310. A length in the axial direction of the sliding base parts 331A and 331B is configured to be longer than a distance between reference end surfaces 310a. The guide shaft parts 332A and 332B are thin cylindrical parts provided on both end surfaces of the sliding base parts 331A and 331B, and are configured in such a manner that shaft centers thereof become identical to shaft centers of the sliding base parts 331A and 331B respectively.

In a spool placed on the upper side in the drawing (hereinafter, referred to as upper spool 330A in case of being distinguished), a first upper annular groove 333A, a second upper annular groove 334A, and a third upper annular groove 335A are provided in an outer peripheral surface of the sliding base part 331A. Similarly, in a spool placed on a lower side of the drawing (hereinafter, referred to as lower spool 330B in case of being distinguished), a first lower annular groove 333B, a second lower annular groove 334B, and a third lower annular groove 335B are provided in an outer peripheral surface of the sliding base part 331B. The first upper annular groove 333A of the upper spool 330A is to switch the pump ports 312 and the upper actuator port 313A between a communicating state and a blocked state. The second upper annular groove 334A is to switch the upper actuator port 313A between a state of communicating with the pump ports 312 and a state of communicating with the drain ports 314. The third upper annular groove 335A is to switch the upper actuator port 313A and the drain ports 314 between a communicating state and a blocked state. The first lower annular groove 333B of the lower spool 330B is to switch the pump ports 312 and the lower actuator port 313B between a communicating state and a blocked state. The second lower annular groove 334B is to switch the lower actuator port 313B between a state of communicating with the pump ports 312 and a state of communicating with the drain ports 314. The third lower annular groove 335B is to switch the lower actuator port 313B and the drain ports 314 between a communicating state and a blocked state.

Also, in the upper spool 330A, a first upper communication groove 336A is provided in the sliding base part 331A between the first upper annular groove 333A and the second upper annular groove 334A, and a second upper communication groove 337A is provided in the sliding base part 331A between the second upper annular groove 334A and the third upper annular groove 335A. Similarly, in the lower spool 330B, a first lower communication groove 336B is provided in the sliding base part 331B between the first lower annular groove 333B and the second lower annular groove 334B, and a second lower communication groove 337B is provided in the sliding base part 3318 between the second lower annular groove 334B and the third lower annular groove 335B. Although not clearly illustrated in the drawings, these communication grooves 336A, 336B, 337A, and 337B are formed in a plurality of positions at equal intervals along peripheral surfaces of the sliding base parts 331A and 331B. In the upper spool 330A, the first upper communication groove 336A and the second upper communication groove 337A are provided in such a manner as to be opened to the first upper annular groove 333A and the third upper annular groove 335A from an outer peripheral surface of the sliding base part 331A. On the other hand, in the lower spool 3308, the first lower communication groove 336B and the second lower communication groove 337B are provided in such a manner as to be opened to the second lower annular groove 334B from an outer peripheral surface of the sliding base part 331B.

More specifically, in a case where the two spools 330A and 330B are arranged in a neutral position illustrated in FIG. 9, the first upper annular groove 333A and the first lower annular groove 333B are opened only to the pump ports 312, the second upper annular groove 334A and the second lower annular groove 334B are respectively opened only to the actuator ports 313A and 313B, and the third upper annular groove 335A and the third lower annular groove 335B are opened only to the drain ports 314. Here, protrusion amounts of the sliding base parts 331A and 331B from the reference end surfaces 310a are configured to be the same at both ends of the valve base part 310.

When each of the spools 330A and 330B moves to a left side from the neutral position illustrated in FIG. 9, as illustrated in FIG. 10-1, while a state in which the first upper annular groove 333A is opened only to the pump ports 312 is kept and a state in which the second upper annular groove 334A is opened only to the upper actuator port 313A is kept, switching to a state in which the third upper annular groove 335A makes the upper actuator port 313A and the drain ports 314 communicate with each other through the second upper communication groove 337A can be performed in the upper spool 330A. On the one hand, in the lower spool 330B, while a state in which the first lower annular groove 333B is opened only to the pump ports 312 is kept and a state in which the third lower annular groove 335B is opened only to the drain port 314 is kept, switching to a state in which the second lower annular groove 334B makes the pump ports 312 and the lower actuator port 313B communicate with each other through the first lower communication groove 336B can be performed.

When each of the spools 330A and 330B moves to a right side from the neutral position illustrated in FIG. 9, as illustrated in FIG. 10-2, while a state in which the second upper annular groove 334A is opened only to the upper actuator port 313A is kept and a state in which the third upper annular groove 335A is opened only to the drain ports 314 is kept, switching to a state in which the first upper annular groove 333A makes the pump ports 312 and the upper actuator port 313A communicate with each other through the first upper communication groove 336A can be performed in the upper spool 330A. On the one hand, in the lower spool 330B, while a state in which the first lower annular groove 333B is opened only to the pump ports 312 is kept and a state in which the third lower annular groove 335B is opened only to the drain ports 314 is kept, switching to a state in which the second lower annular groove 334B makes the lower actuator port 313B and the drain ports 314 communicate with each other through the second lower communication groove 337B can be performed.

Note that a point that a housing box 40 that configures, with the valve base part 310, a valve main body 341 of the hydraulic valve is provided on each of the two reference end surfaces 310a of the valve base part 310, a point that a retainer 44 is arranged at an end part of each of the spools 330A and 330B and a coupling member 45 is arranged in such a manner as to bridge the two spools 330A and 330B, and a point that a return spring 46 is arranged at an end part of each of the spools 330A and 330B are similar to those of the embodiment. Thus, the same sign is assigned with respect to these configurations and a detailed description thereof is omitted.

In the hydraulic valve according to the fourth modification example configured in the above manner, in a case where no pilot pressure is applied to pressure chambers 42 at both ends, each of the spools 330A and 330B is kept in the neutral position illustrated in FIG. 9 by the return springs 46 at both ends. That is, each of the spools 330A and 330B is pressed by the return springs 46 through the coupling members 45 and the retainers 44, and is kept in the neutral position in a state in which both of end surfaces of large-diameter parts 44a provided at both end parts abut on the reference end surfaces 310a of the valve base part 310. Thus, the actuator ports 313A and 313B are in a state of being blocked from both of the pump ports 312 and the drain ports 314, and oil does not circulate to both of the bottom chamber 1a and the rod chamber 1b of the hydraulic cylinder 1 even in a case where the hydraulic pump 324 is driven. That is, the hydraulic cylinder 1 is kept in a stopped state.

From this state, for example, as illustrated in FIG. 10-1, when a pilot pressure is supplied to a pressure chamber 42 on the right side, each of the spools 330A and 330B moves to the left side against a pressing force of a return spring 46 arranged at an end part on the left side. As a result, oil discharged from the hydraulic pump 324 to the supply oil path 323 is supplied to the lower actuator port 313B through the pump ports 312, the first lower communication groove 336B, and the second lower annular groove 334B and is further supplied to the rod chamber 1b of the hydraulic cylinder 1 through the rod oil path 326. Simultaneously, oil stored in the bottom chamber 1a of the hydraulic cylinder 1 is discharged to the upper actuator port 313A through the bottom oil path 325, and is discharged to the tank 322 through the second upper communication groove 337A, the third upper annular groove 335A, the drain ports 314, and the drain oil path 321. Thus, the hydraulic cylinder 1 performs a contraction operation.

On the one hand, as illustrated in FIG. 10-2, when the pilot pressure is supplied to a pressure chamber 42 on the left side from the neutral position illustrated in FIG. 9, each of the spools 330A and 330B moves to the right side against a pressing force of a return spring 46 arranged at an end part on the right side. As a result, the oil discharged from the hydraulic pump 324 to the supply oil path 323 is supplied to the upper actuator port 313A through the pump ports 312, the first upper annular groove 333A, and the first upper communication groove 336A, and is further supplied to the bottom chamber 1a of the hydraulic cylinder 1 through the bottom oil path 325. Simultaneously, oil stored in the rod chamber 1b of the hydraulic cylinder 1 is discharged to the lower actuator port 313B through the bottom oil path 325, and is further discharged to the tank 322 through the second lower communication groove 337B, the third lower annular groove 335B, the drain ports 314, and the drain oil path 321. Thus, the hydraulic cylinder 1 performs an extension operation.

According to this hydraulic valve according to the fourth modification example, the upper actuator port 313A connected only to the bottom chamber 1a of the hydraulic cylinder 1 and the lower actuator port 313B connected only to the rod chamber 1b are included. Thus, there is an advantage such as that a characteristic of the hydraulic cylinder 1 in a contraction operation and a characteristic thereof in an extension operation can be set individually.

In addition, in this hydraulic valve according to the fourth modification example, an operation is performed similarly to the embodiment and moving amounts of the two spools 330A and 330B become identical to each other due to a moment to recover the inclined coupling member 45 in a case where a difference is generated between the moving amounts of the two spools 330A and 330B. Accordingly, a situation in which a gap is generated in oil supply control by the two spools 330A and 330B is prevented, and it becomes possible to accurately perform the oil supply control with respect to the hydraulic cylinder 1.

Note that in each of the above-described embodiment and four modification examples, a hydraulic valve including two spools in a valve main body is exemplified. However, application is possible in a similar manner even when the number of spools is three or more. Also, although what performs oil supply control with respect to a hydraulic cylinder is exemplified, oil supply control can be obviously performed with respect to a different hydraulic pressure device.

Also, in any of the above-described embodiment and four modification examples, a hydraulic valve including two coupling members is exemplified. However, it is not necessarily required to provide two coupling members. For example, in a case where accuracy of a contraction operation of a hydraulic cylinder 1 is not demanded in an embodiment, it is sufficient when a coupling member 45 is provided only on a left side of a spool 30 and it is not necessary to provide a coupling member 45 on a right side of the spool 30. A different modification example is in a similar manner.

### REFERENCE SIGNS LIST

10, 310 VALVE BASE PART
21, 321 DRAIN OIL PATH
23, 323 SUPPLY OIL PATH
25a, 25b, 325 BOTTOM OIL PATH
26a, 26b, 326 ROD OIL PATH
30, 130, 330A, 330B SPOOL
31, 331A, 331B SLIDING BASE PART
32, 332A, 332B GUIDE SHAFT PART
41, 341 VALVE MAIN BODY
42, 142 PRESSURE CHAMBER
44, 144 RETAINER
45, 145, 245 COUPLING MEMBER
45a, 245a INSERTION HOLE
46, 146 RETURN SPRING

1. A hydraulic valve comprising:
two spools which are arranged in a valve main body in a state of being individually movable in an axial direction and being in parallel with each other, individual end parts of which being housed in a common pressure chamber, the two spools having respective guide shaft parts on the end parts thereof;
a return spring provided in such a manner as to be placed between each of the spools and the valve main body, so that a flow of oil with respect to an oil path connected to the valve main body is controlled by a movement of the two spools with respect to the valve main body against a spring force of each of the return springs in a case where a pilot pressure is supplied to the pressure chamber; and
a coupling member that is arranged in such a manner as to bridge the guide shaft parts of the two spools and that is pressed in a direction of becoming closer to the spools by the return springs since being placed between each of the spools and the return springs.

2. The hydraulic valve according to claim 1, wherein the return springs and the coupling member are provided at each of both end parts of the spools.

3. The hydraulic valve according to claim 1, wherein the return springs are provided at one end parts of the spools and the coupling member, which is provided in each of parts which are to be both ends of the return springs and is placed therebetween, the return springs are compressed between one of the coupling members and the valve main body in a case where the spools move in a first direction, and the return springs are compressed between another coupling member and the valve main body in a case where the spools move in a second direction.

4. The hydraulic valve according to claim 1,
wherein in each of the spools, a thin guide shaft part is provided at an end part of a sliding base part,
two insertion holes having an inner diameter larger than an outer diameter of the guide shaft part are provided in the coupling member and the guide shaft part is inserted into each of the insertion holes,
a retainer having an outer diameter larger than the spools is placed between the coupling member and the spools, and
the coupling member is pressed to the spools by the return springs through the retainer.
